(19) United States
(12) Patent Application Publication
(10) Pub. No.: US 2022/0405347 A1
(43) Pub. Date: Dec. 22, 2022

(54) DATA PROCESSING APPARATUS, COMPUTER-READABLE RECORDING MEDIUM STORING PROGRAM OF PROCESSING DATA, AND METHOD OF PROCESSING DATA

(71) Applicant: FUJITSU LIMITED, Kawasaki-shi (JP)

(72) Inventors: Hirotaka Tamura, Yokohama (JP); Kouichi Kanda, Chofu (JP)

(73) Assignee: FUJITSU LIMITED, Kawasaki-shi (JP)

(21) Appl. No.: 17/839,529

(22) Filed: Jun. 14, 2022

(30) Foreign Application Priority Data
Jun. 21, 2021 (JP) 2021-102484

(51) Int. Cl. G06F 17/11; G06F 7/02; G06F 7/544

(52) U.S. Cl. CPC G06F 17/11; G06F 7/02; G06F 7/5443

(57) ABSTRACT

A computer of searching for a combination of state variables with which an evaluation function including the state variables becomes a local minimum or maximum, the computer including: a memory storing a first coefficient indicating a magnitude of interaction between k state variables in a kth order term of the evaluation function; and a processor that performs: calculating a first local field indicating a change amount of the kth order term when a first state variable among the k state variables changes by the first coefficient and a first variable obtained by the k state variables and second coefficients; and determining whether to allow a change in the first state variable based on a result of comparison between a predetermined value and a product of a sum of the first local field and a second local field indicating a change amount of quadratic and lower-order terms of the evaluation function.

### CROSS-REFERENCE TO RELATED APPLICATION

This application is based upon and claims the benefit of priority of the prior Japanese Patent Application No. 2021-102484, filed on Jun. 21, 2021, the entire contents of which are incorporated herein by reference.

### FIELD

The embodiments discussed herein are related to a data processing apparatus, a computer-readable recording medium storing a program, and a method of processing data.

### BACKGROUND

As an apparatus that calculates a large-scale discrete optimization problem which is not easily handled by a Neumann-type computer, there is an Ising machine (also referred to as a Boltzmann machine) using an Ising-type evaluation function (also referred to as an energy function or the like).

The Ising machine converts a discrete optimization problem into an Ising model representative of a behavior of a spin of a magnetic body. Based on the Markov chain Monte Carlo method such as a simulated annealing method or a replica exchange method (also referred to as, for example, a parallel tempering method), the Ising machine searches for a state of the Ising model that sets a value of the Ising type evaluation function (corresponding to energy) to a local minimum. A state having the minimum value out of the local minimums of the evaluation function is an optimal solution. By changing the sign of the evaluation function, the Ising machine is also able to search for a state that sets the value of the evaluation function to a local maximum. The state of the Ising model may be expressed by a combination of values of a plurality of state variables. As the value of each of the state variables, 0 or 1 may be used.

The Ising-type evaluation function is defined by, for example, a function of a quadratic form such as Expression (1) below.

$$E = - {\sum }_{i = 1}^{N} {\sum }_{j > i}^{N} {W}_{ij} {x}_{i} {x}_{j} - {\sum }_{i = 1}^{N} {b}_{i} {x}_{i} \qquad ( 1 )$$

The first term on the right side is the total of products each obtained from values of two state variables and a weight value (indicative of the intensity of interaction between the two state variables) in one of all the combinations, without omission and duplication, of N state variables in the Ising model. Here, xᵢ is a state variable with an identification number i, xⱼ is a state variable with an identification number j, and Wᵢⱼ is a weight value indicative of the intensity of interaction between the state variables with the identification numbers i and j. The second term on the right side is the total sum of products each obtained from a bias coefficient and a state variable for one of the identification numbers. Here, bᵢ indicates a bias coefficient for the identification number=i.

An energy change amount (ΔEᵢ) due to a change in the value of xᵢ is represented by Expression (2) below.

$$Δ {E}_{i} = - Δ {x}_{i} ( {\sum }_{j}^{N} {W}_{ij} {x}_{j} + {b}_{i} ) = - Δ {x}_{i} {h}_{i} \qquad ( 2 )$$

In Expression (2), for example, Δxᵢ is −1 when xᵢ which is a value of 0 or 1 changes from 1 to 0, whereas Δxᵢ is 1 when xᵢ changes from 0 to 1. Here, hᵢ is referred to as a local field and ΔEᵢ is the product of hᵢ and a sign (+1 or −1) depending on Δxᵢ. For this reason, hᵢ may also be referred to as a variable that represents the energy change amount or a variable that determines the energy change amount.

For example, in the case where ΔEᵢ is smaller than a noise value obtained based on a random number and a value of a temperature parameter, a process of updating the value of xᵢ to generate a state transition and also updating the local fields is repeated.

The related-art Ising machine uses an Ising-type evaluation function defined by a quadratic-form function as represented by Expression (1) above. To allow application of the Ising machine to a wider variety of discrete optimization problems, it is conceivable to use an evaluation function including a cubic or higher-order term (hereafter referred to as a higher-order evaluation function).

As a calculation technique for a discrete optimization problem using a higher-order evaluation function, a technique has been proposed in which, by adding a new independent variable similar to a state variable, a higher-order evaluation function is converted into a quadratic evaluation function and calculated.

Also, a technique has been proposed in which a constraint term of an inequality constraint defined by a linear-form function remaining in the linear form is used and a solution is obtained by an Ising machine.

Examples of the related art include as follows: Japanese Laid-open Patent Publication No. 2020-204928.

Examples of the related art also include as follows: R. Xia, et al. “Electronic Structure Calculations and the Ising Hamiltonian”, J. Phys. Chem. B 2018, 122, 13, 3384-3395, 2017.

### SUMMARY

According to an aspect of the embodiments, there is provided a data processing apparatus of searching for a combination of values of a plurality of state variables with which a value of an evaluation function which includes the plurality of state variables becomes a local minimum or a local maximum. In an example, the data processing apparatus includes: a storage device configured to store a first coefficient indicating a magnitude of interaction between k state variables (k is an integer of greater than or equal to three) out of the plurality of state variables included in a kth order term of the evaluation function; and a processor configured to perform processing including: calculating a first local field indicative of a change amount of the kth order term in a case where a value of a first state variable out of the k state variables changes based on a value of a first variable and the first coefficient read from the storage device, the value of the first variable being a value obtained based on values of the k state variables and a plurality of second coefficients respectively representative of influences of the k state variables on the first variable; and determining, based on a result of comparison, whether to allow a change in the value of the first state variable, the result of the comparison being obtained by comparing between a predetermined value and a product of a sum of the first local field and a second local field indicative of a change amount of quadratic and lower-order terms of the evaluation function in the case where the value of the first state variable changes and a change amount of the first state variable.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a data processing apparatus and a method of processing data according to a first embodiment;

FIG. 2 illustrates an example of k auxiliary variables used corresponding to k state variables;

FIG. 3 illustrates the relationship between yⱼₙ and qⱼₙ;

FIG. 4 is a block diagram illustrating a hardware example of a data processing apparatus according to a second embodiment;

FIG. 5 is a block diagram illustrating a functional example of the data processing apparatus;

FIG. 6 illustrates an example of matrix information stored in a storage unit;

FIG. 7 is a flowchart illustrating a flow of an example of the method of processing data;

FIG. 8 is a flowchart illustrating a flow of an example of a procedure of the initialization process;

FIG. 9 is a flowchart illustrating a flow of an example of a procedure of an updating process;

FIG. 10 illustrates an example of a data processing apparatus according to a third embodiment;

FIG. 11 illustrates a configuration an example of a field-programmable gate array (FPGA);

FIG. 12 illustrates an example in which an auxiliary variable having a value of two bits is used;

FIG. 13 illustrates an example in which spin variables are used as the state variables;

FIG. 14 illustrates an example in which the number of the auxiliary variables used for the state variables that are k spin variables included in the kth term is one;

FIG. 15 illustrates an example in which a plurality of auxiliary variables are used in a plurality of layers; and

FIG. 16 illustrates an example of calculation results.

### DESCRIPTION OF EMBODIMENTS

With the related-art technique in which the independent variable is added and the higher-order evaluation function is converted into the quadratic evaluation function, the number of independent variables increases as the degree of higher-order terms increases. When the number of independent variables increases, the size of the solvable problem decreases, and the solution space increases. Consequently, it may be difficult to solve a problem.

In one aspect, an object of the present disclosure is to provide a data processing apparatus, a program, and a method of processing data with which a discrete optimization problem represented by a higher-order evaluation function may be calculated without increasing the number of independent variables.

Hereinafter, the embodiments of the present disclosure will be described with reference to the drawings.

### First Embodiment

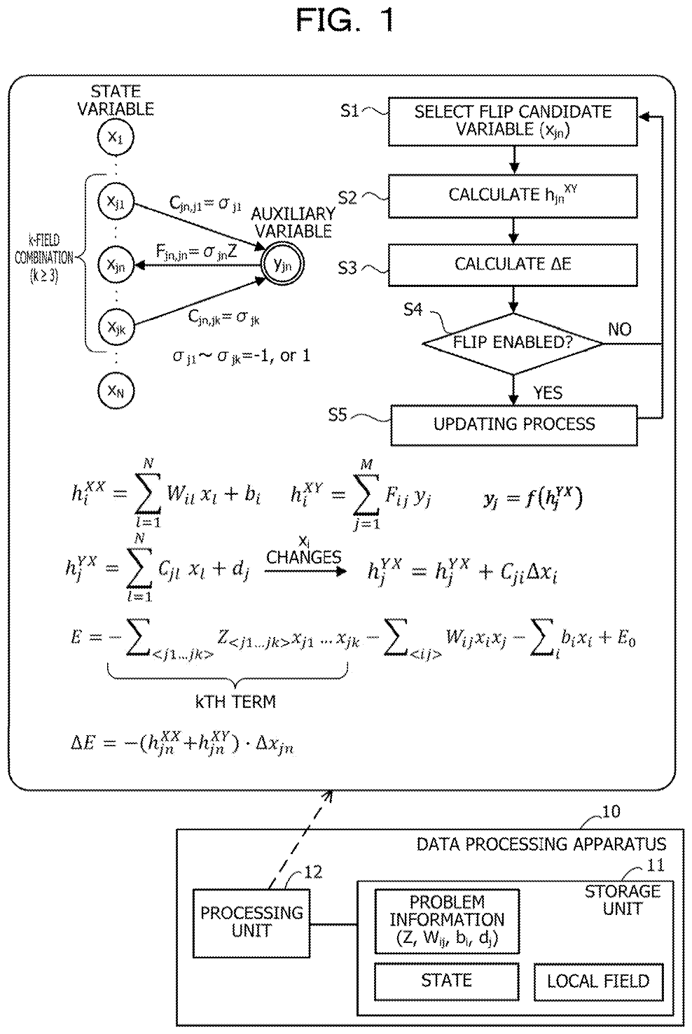

FIG. 1 illustrates an example of a data processing apparatus and a method of processing data according to a first embodiment.

A data processing apparatus 10 according to the first embodiment is an apparatus that searches for a combination of values of a plurality of state variables with which a value of a higher-order evaluation function as described above becomes a local minimum or a local maximum.

In the case where a constraint condition to be satisfied by a problem is given by a complex desired combination of various conditions, the constraint condition may be given in a satisfiability problem (SAT). In this case, for example, it is desirable that the number of logical clauses unable to be satisfied by the SAT become the minimum value. Although all SATs may be converted into a 3-SAT in which the number of literals is three, the related-art Ising machine which is only able to handle an evaluation function of the quadratic form is able to directly solve only up to a 2-SAT. As described below, the data processing apparatus 10 according to the present embodiment calculates a local field representative of a change amount (the energy change amount) of a higher-order term due to a change in values of the state variables included in the higher-order term by using an auxiliary variable. With this technique, the data processing apparatus 10 enables calculation of a problem equal to or higher than the 3-SAT, for example.

A higher-order evaluation function may be represented by, for example, the following Expression (3).

$$E = - {\sum }_{〈 j 1 … jk 〉} {Z}_{〈 j 1 … jk 〉} {x}_{j 1} … {x}_{jk} - {\sum }_{〈 ij 〉} {W}_{ij} {x}_{i} {x}_{j} - {\sum }_{i} {b}_{i} {x}_{i} + {E}_{0} \qquad ( 3 )$$

On the right side, the first term is a kth (k≥3) term (higher-order term), and the second and subsequent terms are quadratic and lower-order terms. Out of N state variables, xⱼ₁ to xⱼₖ are state variables that are included in the kth term and forms a k-field combination. In Expression (3), Z<_{j1 . . . jk}> is a coefficient representative of the magnitude of interaction between xⱼ₁ to xⱼₖ (for example, it may also be said to be a coefficient representative of the strength of combination of the k-field combination).

In the case where the constraint condition of the SAT type discrete optimization problem is handled, in the higher-order term, the part representative of the product of xⱼ₁ to xⱼₖ may be the product of positive and negative literals. For example, in the case where k=4 and xⱼ₁=x₁, xⱼ₂=x₂, xⱼ₃=x₃, xⱼ₄=x₄, the product such as Expression (4) below may also be handled as a higher-order term.

x̅₁̅x₂x̅₃̅x₄=(1−x₁)x₂(1−x₃)x₄ (4)

IN Expression (4), state variables (x₁, x₃) with a bar are negative literals. In the case of such a higher-order term, when the logical clause of Expression (5) below is not satisfied, for example, in the case of Expression (6) below, Z_{<j1 . . . jk>} contributes to E (energy) (cost is generated).

x₁∨x̅₂̅∨x₃∨x̅₄̅ (5)

x̅₁̅∧x₂∧x̅₃̅∧x₄=1 (6)

It is assumed that, in the case where the logical clause of Expression (5) is not satisfied, Z₁₂₃₄ is generated as Z_{<j1 . . . jk>}. A biquadratic term that generates such Z₁₂₃₄ may be represented as Z₁₂₃₄(1−x₁)x₂(1−x₃)x₄. In the case where the value of each of x₁ to x₄ changes, a corresponding local field (h₁^{XY} to h₄^{XY}) indicative of a change amount of the above biquadratic term may be represented as follows by using a corresponding auxiliary variable (y₁ to y₄).

For example, the change amount of the biquadratic term in the case where the value of x₁ changes indicated by h₁^{XY} may be represented as h₁^{XY}=−Z₁₂₃₄y₁ by using y₁ that is y₁=x₂(1−x₃)x₄. The change amount of the biquadratic term in the case where the value of x₂ changes indicated by h₂^{XY}, may be represented as h₂^{XY}=+Z₁₂₃₄y₂ by using y₂ that is y₂=(1−x₁)(1−x₃)x₄. The change amount of the biquadratic term in the case where the value of x₃ changes indicated by h₃^{XY} may be represented as h₃^{XY}=−Z₁₂₃₄y₃ by using y₃ that is y₃=(1−x₁)x₂x₄. The change amount of the biquadratic term in the case where the value of x₄ changes indicated by h₄^{XY} may be represented as h₄^{XY}=+Z₁₂₃₄y₄ by using y₄ that is y₄=(1−x₁)x₂(1−x₃).

A value obtained by multiplying hᵢ^{XY} by −Δxᵢ is an increase in energy with the biquadratic term in the case where yᵢ=1.

As described above, when all the literals other than x₁ generating hᵢ^{XY} out of the literals of k state variables included in the kth term are 1, hᵢ^{XY} is a value obtained by adding an appropriate sign to Z<_{j1 . . . jk>}. In contrast, when even one of the literals other than xᵢ is false (0), hᵢ^{XY} is 0.

A value to which an appropriate sign is added means that a positive sign is added in the case where xᵢ that generates hᵢ^{XY} is a positive literal in the kth order term and a negative sign is added in the case where xᵢ that generates hᵢ^{XY} is a negative literal in the kth term.

Using the auxiliary variables as described above allows calculation of hᵢ^{XY} that is the local field indicative of the change amount of the kth term in the case where the values of the state variables included in the kth term change.

Since the auxiliary variables are obtained from the values of the state variables, the auxiliary variables are not independent variables and do not increase a solution searching space.

The data processing apparatus 10 illustrated in FIG. 1 calculates, by using three types of local fields (hᵢ^{XX}, hᵢ^{XY}, hⱼ^{YX}) including the above-described hᵢ^{XY} and the auxiliary variables as described above, a change amount (ΔE) of the value of the evaluation function of Expression (3) in the case where the value of xᵢ changes and determines whether to allow a change in a value of xᵢ.

The data processing apparatus 10 according to the first embodiment includes a storage unit 11 and a processing unit 12.

The storage unit 11 is, for example, a volatile storage device including an electronic circuit such as a dynamic random-access memory (DRAM) or a non-volatile storage device including an electronic circuit such as a hard disk drive (HDD) or a flash memory. The storage unit 11 may include an electronic circuit such as a register.

The storage unit 11 stores problem information of the discrete optimization problem, values of a plurality of (hereafter, N) state variables included in the evaluation function of Expression (3), and values of hᵢ^{XX}, hᵢ^{XY}, hⱼ^{YX}.

The problem information includes, for example, a coefficient (dⱼ), which will be described later, other than Z_{<j1 . . . jk>} (simply represented as Z in FIG. 1), Wᵢⱼ, and bᵢ represented in Expression (3).

The local field hᵢ^{XX} is a local field representative of the change amount of the quadratic and lower-order terms of the value of the evaluation function of Expression (3) in the case where the value of xᵢ changes and corresponds to hᵢ of Expression (2). For example, hᵢ^{XX} may be represented by Expression (7) below.

$${h}_{i}^{XX} = {\sum }_{l = 1}^{N} {W}_{il} {x}_{l} + {b}_{i} \qquad ( 7 )$$

The local field hⱼ^{YX} is a first local field for the kth term and indicates a local field that N state variables generate for the auxiliary variable. The local field Hⱼ^{YX} may be represented by Expression (8) below.

$${h}_{j}^{YX} = {\sum }_{l = 1}^{N} {C}_{jl} {x}_{l} + {d}_{j} \qquad ( 8 )$$

In Expression (8), Cⱼₗ is a coefficient representative of the influence of the xₗ on the jth auxiliary variable. Assuming that the state variables not included in the kth term do not influence the auxiliary variable used for this kth term, Cⱼₗ related to these state variables is 0.

As described above, in the case where the kth term is represented by the product of positive and negative literals, the C_{jn,j1} to C_{jn,jk} representative of the influence of the xⱼ₁ to xⱼₖ included in the kth term on yⱼₙ may be represented by σⱼ₁ to σⱼₖ being appropriate signs described above. For example, in the case where is included in the above product as a positive literal, σⱼₙ=+1, and in the case where xⱼₙ is included in the above product as a negative literal (1−xⱼₙ), σⱼₙ=−1.

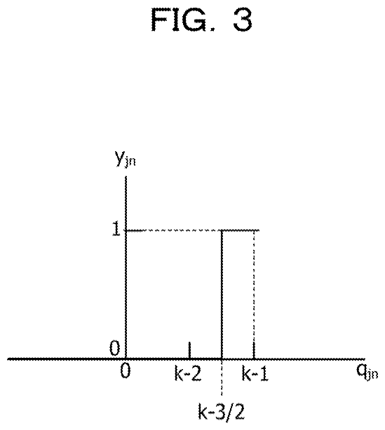

In Expression (8), dⱼ is, for example, a predetermined constant such as −(k−(3/2)) (see FIG. 3).

An updated value of Hⱼ^{YX} due to the change in the value of xᵢ may be represented as hⱼ^{YX}=hⱼ^{YX}+CⱼᵢΔxᵢ.

The local field hᵢ^{XY} is a second local field for the kth term and, as described above, indicates the change amount of the kth term in the case where the values of the state variables included in the kth term change. According to the first embodiment, hᵢ^{XY} indicates a local field that a certain auxiliary variable generates for xᵢ. Expression (9) below may represent hᵢ^{XY}.

$${h}_{i}^{XY} = {\sum }_{j = 1}^{M} {F}_{ij} {y}_{j} \qquad ( 9 )$$

In Expression (9), yⱼ is a jth auxiliary variable out of M auxiliary variables and may be represented as yⱼ=f(hⱼ^{YX}). In this expression, f is a function representative of the input and output relationship of yⱼ.

In this expression, Fᵢⱼ indicates the strength of the influence of the jth auxiliary variable on the xᵢ. For example, the product of Z_{<j1 . . . jk>} indicated in Expression (3) above and a coefficient (Cⱼₗ) representative of the influence of xᵢ on the jth auxiliary variable is used as Fᵢⱼ.

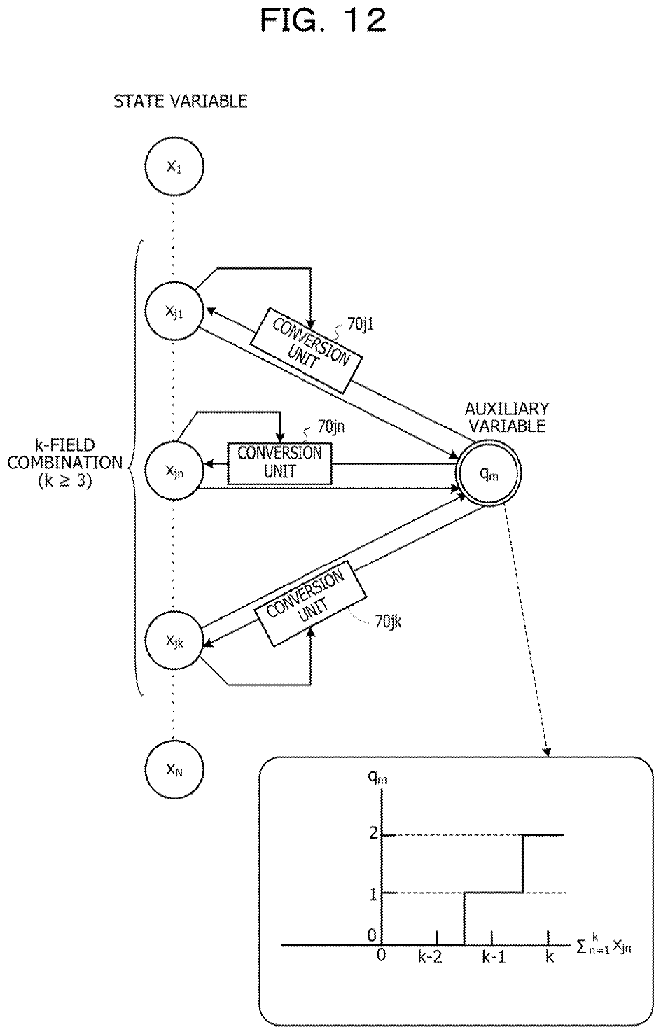

According to the first embodiment, k auxiliary variables that are values of a single bit of 0 or 1 are used corresponding to the number of k state variables (xⱼ₁ to xⱼₖ) included in the kth term. The auxiliary variables may be variables having a value of two or more bits. In this case, the number of the auxiliary variables may be one for k state variables (see a fourth embodiment (FIG. 12) to be described later).

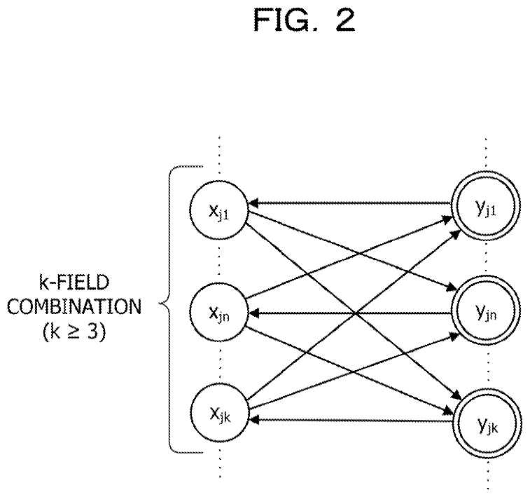

FIG. 2 illustrates an example of k auxiliary variables used corresponding to k state variables.

Each of the k auxiliary variables (yⱼ₁ to yⱼₖ) generates the local field (hⱼ₁^{XY} to hⱼₖ^{XY}) for one of xⱼ₁ to xⱼₖ. Each of yⱼ₁ to yⱼₖ is determined based on a total sum of the products of the values of the state variables out of xⱼ₁ to xⱼₖ other than the state variable for which the local field is generated and a subset of σⱼ₁ to σⱼₖ described above related to the state variables other than the state variable for which the local field is generated.

In FIG. 1, for simplicity of explanation, one of the auxiliary variables (yⱼₙ) is illustrated. For xⱼₙ, yⱼₙ generates a local field (hⱼₙ^{XY}).

The local field (hⱼₙ^{XY}) that yⱼₙ generates for xⱼₙ may be represented as hⱼₙ^{XY}=σⱼₙZyⱼₙ by using σⱼₙ and Z described above.

A function f(hⱼₙ^{YX}) that determines yⱼₙ is a function that determines a value of yⱼₙ in accordance with a value of qⱼₙ represented by Expression (10) below.

$${q}_{jn} = {\sum }_{l = 1 , l \neq n}^{k} {σ}_{jl} {x}_{jl} + {N}_{negative} \qquad ( 10 )$$

The first term on the right side of Expression (10) is a value obtained by subtracting σⱼₙxⱼₙ and dⱼ from hⱼₙ^{YX} obtained based on Expression (8). The second term, N_{negative} on the right side of Expression (10) is the number of state variables included in the above-described product as negative literals in the xⱼₗ (l=1 to k, l≠jn).

FIG. 3 illustrates the relationship between yⱼₙ and qⱼₙ. The horizontal axis represents qⱼₙ and the vertical axis represents yⱼₙ.

In the case of k−1 at which the qⱼₙ is the maximum, yⱼₙ is 1, and in the case of smaller than k−1 (in the case of k−2 or smaller) yⱼₙ is 0. As a threshold for such determination, the indicated in Expression (8) is used.

In this way, hⱼₙ^{XY} representative of the change amount of the kth term in the case where the value of xⱼₙ changes may be obtained.

For example, as described above, the biquadratic term that generates Z₁₂₃₄ in the case where the logical clause of Expression (5) is not satisfied may be represented as Z₁₂₃₄(1−x₁)x₂(1−x₃)x₄. In the case of jn=1, it may be determined that y₁ used for calculation of h₁^{XY} generated for x₁ is 1 or 0 depending on whether q₁=x₂−x₃+x ₄+1 is equal to or greater than (k−(3/2))=2.5. Thus, y₁=f(h₁^{YX}) is the same expression as y₁=x₂(1−x₃)x₄ described above. For example, in the case where x₂=1, x₃=0, and x₄=1, q₁=3 and q₁ is k−1. Thus, y₁=1.

The storage unit 11 illustrated in FIG. 1 may store σⱼ₁ to σⱼₖ used in the above-described calculation.

The storage unit 11 may store various types of data such as calculation conditions used when the processing unit 12 executes the method of processing data, which will be described later (for example, the number of replicas, a value of a temperature parameter set for each of the replicas, a replica exchange cycle, and a calculation end condition in the case where a replica exchange method is executed). In the case where the processing unit 12 executes part or the entirety of processing of the method of processing data, which will be described later, by using software, a program for executing the processing is stored in the storage unit 11.

For example, the processing unit 12 may be realized by using a processor that is hardware such as a central processing unit (CPU), a graphics processing unit, (GPU) or a digital signal processor (DSP). Instead, the processing unit 12 may be realized by using an electronic circuit such as an application-specific integrated circuit (ASIC) or a field-programmable gate array (FPGA).

For example, the processing unit 12 searches for a state in which the value of the evaluation function (energy) represented by Expression (3) becomes the local minimum. The optimal solution is a state having the minimum value among the local minimums of the evaluation function. By changing the sign of the evaluation function represented by Expression (3), the processing unit 12 may search for a state in which the value of the evaluation function becomes the local maximum (in this case, a state having the maximum value is the optimal solution).

FIG. 1 illustrates a flow of an example of part of processing performed by the processing unit 12.

Here, it is assumed that values based on the initial values of x₁ to x_{N} are stored in the storage unit 11 as hᵢ^{XX}, hᵢ^{XY}, hⱼ^{YX}, yⱼ, and E.

The processing unit 12 selects, out of x₁ to x_{N}, a candidate state variable the value of which is to be changed (hereafter referred to as a flip candidate) (step S1). For example, the processing unit 12 selects a flip candidate state variable randomly or in a predetermined order. A case where xⱼₙ included in the kth term is selected is described below.

In the case where the value of xⱼₙ changes, the processing unit 12 calculates (or updates) hⱼₙ^{XY} based on the updated value of hⱼ^{YX} (=hⱼₙ^{YX}) by using the above-described method (step S2).

The processing unit 12 calculates the change amount (ΔE) of the value of the evaluation function in the case where the value of xⱼₙ changes by using the product of −Δxⱼₙ and the sum of hⱼₙ^{XY} and hᵢ^{XX}(=hⱼₙ^{XX}) obtained based on Expression (7) (step S3).

Based on a result of comparison between ΔE and a predetermined value, the processing unit 12 determines whether to allow a change in the value of xⱼₙ (whether to enable or disable the flipping) (step S4). Hereinafter, this determination process is referred to as a flip determination process.

The predetermined value is, for example, a noise value obtained based on a random number and the value of a temperature parameter. The processing unit 12 determines that the change in the value of xⱼₙ is allowed in the case where, for example, ΔE is smaller than log (rand)×T which is an example of the noise value obtained based on a uniform random number (rand) of greater than or equal to 0 and smaller than or equal to 1 and the temperature parameter (T).

In the case where it is determined that the flip is enabled, the processing unit 12 updates the state stored in the storage unit 11 by changing the value of xⱼₙ and performs an updating process that updates hᵢ^{XX}, hᵢ^{XY}, hⱼ^{YX}, and y due to the change (step S5).

For example, updating of hᵢ^{XX} (i=1 to N) due to the change in the value of xⱼₙ may be performed by using the following expression: hᵢ^{XX}=hᵢ^{XX}+W_{i,jn}Δxⱼₙ. For example, it is sufficient that the processing unit 12 read weight values in a jn column in a matrix W of N×N weight values.

Updating hⱼ^{YX} and hᵢ^{XY} may be performed by determining updated values obtained when hⱼₙ^{XY} is calculated in the processing of step S2.

After the processing of step S5 or in the case where the flip is determined not to be enabled in the processing of step S4, the processing unit 12 repeatedly performs the processing from step S1 until a predetermined end condition is satisfied.

The order of the above-described processes is merely exemplary and may be changed as appropriate.

Although an example in which the processing of steps S2 to S4 is performed by selecting the flip candidate state variables one by one out of N state variables has been described in the above description, the processing of steps S2 to S4 may be performed in parallel for a plurality of (for example, all of N) state variables. In this case, when there are a plurality of state variables the values of which are allowed to be changed, the processing unit 12 selects the state variables the values of which are to be changed randomly or in accordance with a predetermined rule to perform the updating process of step S5. The parallel processing as described above increases the speed of the calculation.

In the case of performing a simulated annealing method, the processing unit 12 decreases the value of the above-described temperature parameter (T) according to a predetermined temperature parameter change schedule every time, for example, the flip determination process is repeatedly performed a predetermined number of times. The processing unit 12 outputs the state obtained in the case where the flip determination process has been repeatedly performed the predetermined number of times as a calculation result of the discrete optimization problem (for example, displays on a display device not illustrated). The processing unit 12 may update the value of the evaluation function (energy) represented by Expression (3) every time the change in the value of the state variable is generated and cause the storage unit 11 to hold the energy and the state in the case where the energy becomes the minimum energy up to that time. In this case, the processing unit 12 may output, as the calculation result, the state corresponding to the minimum energy stored after the flip determination process have been repeatedly performed the predetermined number of times.

In the case where the processing unit 12 performs the replica exchange method, the processing unit 12 performs the processing of steps S1 to S5 described above in a plurality of different replicas in which different values of the temperature parameter are set. Every time the flip determination process is repeatedly performed a predetermined number of times, the processing unit 12 performs a replica exchange. For example, the processing unit 12 randomly selects two replicas out of the plurality of replicas and exchanges the value of the temperature parameter or the state between the two selected replicas with a predetermined exchange probability based on an energy difference between the replicas and the difference in the value of the temperature parameter between the replicas. For example, the processing unit 12 updates the value of the evaluation function (energy) represented by Expression (3) every time the change in the value of the state variable is generated in each of the replicas and holds the energy and the state in the case where the energy becomes the minimum energy up to that time. The processing unit 12 outputs, as the calculation result, the state corresponding to the minimum energy in all the replicas out of the minimum energies stored after the above-described flip determination process has been repeatedly performed the predetermined number of times in each of the replicas.

With the data processing apparatus 10 and the method of processing data as described above, the change amount of the kth term in the case where the values of the state variables included in the kth term change is calculated by using the values of the auxiliary variables obtained based on the values of the state variables included in the kth term. Since the auxiliary variables are not independent variables or do not increase a solution searching space. Accordingly, the discrete optimization problem represented by a higher-order evaluation function may be calculated without increasing the number of independent variables.

Since the combination between the state variables and the auxiliary variables is represented by the coefficient (Cⱼₗ of Expression (8) or Fᵢⱼ of Expression (9)) as described above, wiring or the like is not desired, and even when the number of auxiliary variables increases, a problem such as wiring jam does not occur.

### Second Embodiment

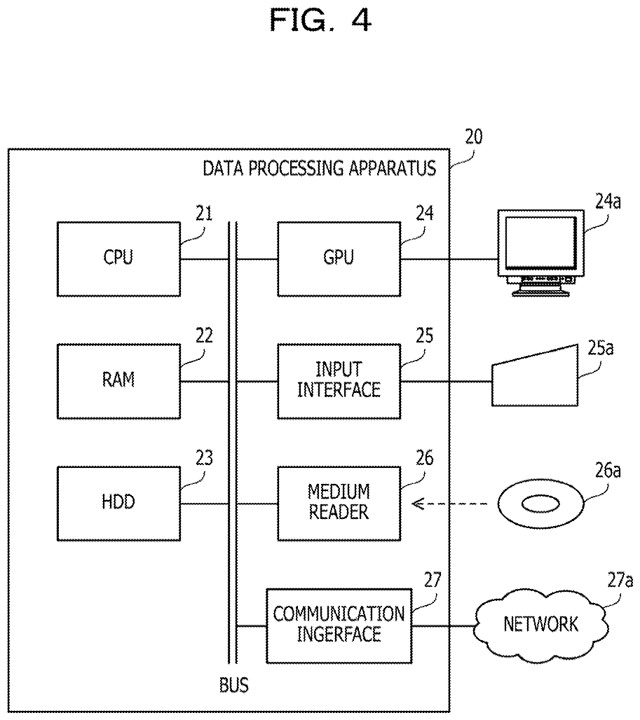

FIG. 4 is a block diagram illustrating a hardware example of a data processing apparatus according to a second embodiment.

The data processing apparatus 20 is, for example, a computer and includes a CPU 21, a random-access memory (RAM) 22, an HDD 23, a GPU 24, an input interface 25, a medium reader 26, and a communication interface 27. The above-described devices are coupled to a bus.

The CPU 21 is a processor including an arithmetic circuit that executes program instructions. The CPU 21 loads at least a subset of programs and data stored in the HDD 23 into the RAM 22 and executes the programs. The CPU 21 may include a plurality of processor cores, or the data processing apparatus 20 may include a plurality of processors. Processes to be described below may be executed in parallel by using the plurality of processors or processor cores. A set of a plurality of processors (multiprocessor) may be referred to as a “processor”.

The RAM 22 is a volatile semiconductor memory that temporarily stores the programs executed by the CPU 21 or the data used for the arithmetic by the CPU 21. The data processing apparatus 20 may include a memory of a type other than the type of the RAM 22 and may include a plurality of memories.

The HDD 23 is a non-volatile storage device that stores the programs of software such as an operating system (OS), middleware, and application software, and data. Examples of the programs include a program for causing the data processing apparatus 20 to execute a process of searching for a solution to a discrete optimization problem. The data processing apparatus 20 may include another type of the storage device such as a flash memory or a solid-state drive (SSD) and may include a plurality of non-volatile storage devices.

The GPU 24 outputs images to a display 24a coupled to the data processing apparatus 20 in accordance with instructions from the CPU 21. As the display 24a, a cathode ray tube (CRT) display, a liquid crystal display (LCD), a plasma display panel (PDP), an organic electro-luminescence (OEL) display, or the like may be used.

The input interface 25 obtains an input signal from an input device 25a coupled to the data processing apparatus 20 and outputs the input signal to the CPU 21. As the input device 25a, a pointing device such as a mouse, a touch panel, a touchpad, and a trackball, as well as a keyboard, a remote controller, a button switch, or the like may be used. A plurality of types of input devices may be coupled to the data processing apparatus 20.

The medium reader 26 is a reading device that reads programs and data recorded in a recording medium 26a. As the recording medium 26a, for example, a magnetic disk, an optical disk, a magneto-optical (MO) disk, a semiconductor memory, or the like may be used. Examples of the magnetic disk include a flexible disk (FD) and an HDD. Examples of the optical disk include a compact disc (CD) and a Digital Versatile Disc (DVD).

For example, the medium reader 26 copies the programs or the data read from the recording medium 26a to another recording medium such as the RAM 22 or the HDD 23. For example, the read programs are executed by the CPU 21. The recording medium 26a may be a portable-type recording medium and, in some cases, is used to distribute the programs and the data. The recording medium 26a and the HDD 23 may be referred to as computer-readable recording media.

The communication interface 27 is an interface that is coupled to a network 27a and that communicates with another information processing apparatus via the network 27a. The communication interface 27 may be a wired communication interface coupled to a communication device such as a switch via a cable or a wireless communication interface coupled to a base station via a wireless link.

Next, the functions and a processing procedure of the data processing apparatus 20 are described.

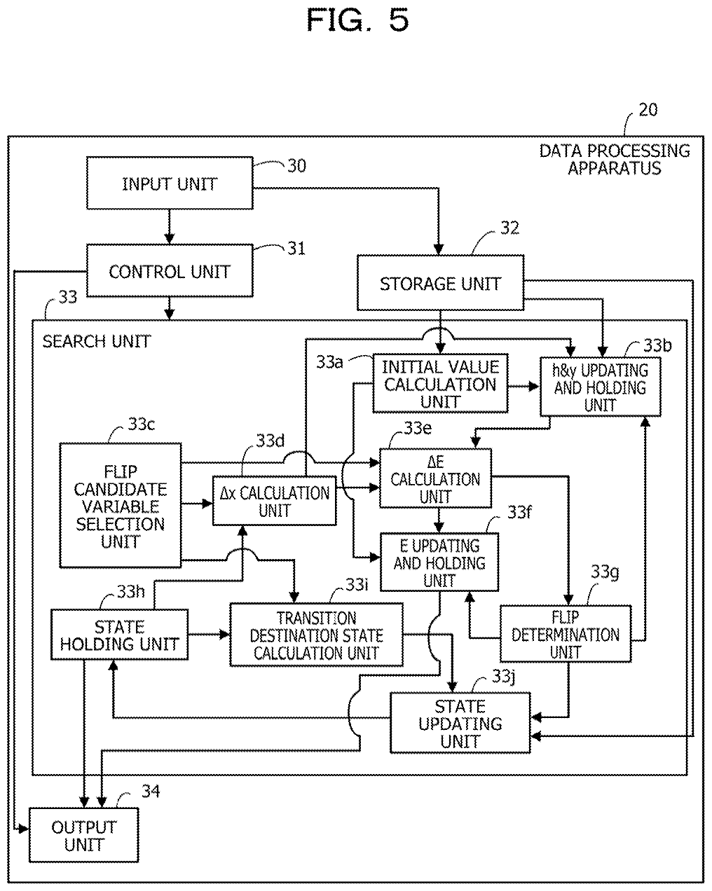

FIG. 5 is a block diagram illustrating a functional example of the data processing apparatus.

The data processing apparatus 20 includes an input unit 30, a control unit 31, a storage unit 32, a search unit 33, and an output unit 34.

The input unit 30, the control unit 31, the search unit 33, and the output unit 34 have the function of the processing unit 12 of the data processing apparatus 10 according to the first embodiment. The input unit 30, the control unit 31, the search unit 33, and the output unit 34 may be implemented by using, for example, program modules executed by the CPU 21 or a storage area (a register or a cache memory) in the CPU 21. The storage unit 32 has the function of the storage unit 11 of the data processing apparatus 10 according to the first embodiment. The storage unit 32 may be implemented by using, for example, a storage area reserved in the RAM 22 or the HDD 23.

The input unit 30 accepts, for example, input of initial values of the state variables (xᵢ to x _{N}), the problem information, and calculation conditions. The problem information includes, for example, the coefficients (Cⱼₗ, dⱼ) indicated in Expression (8) in addition to Z_{<j1 . . . jk>}, the weight value (Wᵢⱼ), and the bias coefficient (bᵢ) indicated in Expression (3). The problem information may include Fᵢⱼ that is a value obtained by multiplying Z_{<j1 . . . jk>} by πⱼ₁ to ϕⱼₖ described above. Examples of the calculation conditions include, for example, the number of replicas, the replica exchange cycle, the value of the temperature parameter set for each of the replicas in the case where the replica exchange method is executed, and the temperature parameter change schedule, the calculation end condition, and so forth in the case where the simulated annealing method is performed.

These pieces of information may be input by a user operating the input device 25a or input via the recording medium 26a or the network 27a.

Based on the calculation conditions and the like, the control unit 31 controls the units in the data processing apparatus 20 to cause the units to execute processing to be described later.

The storage unit 32 stores the initial values of x₁ to x_{N} and the problem information. The storage unit 32 may store various types of information such as the calculation conditions.

The search unit 33 includes an initial value calculation unit 33a, an h&y updating and holding unit 33b, a flip candidate variable selection unit 33c, a Δx calculation unit 33d, a ΔE calculation unit 33e, and an E updating and holding unit 33f. The search unit 33 further includes a flip determination unit 33g, a state holding unit 33h, a transition destination state calculation unit 33i, and a state updating unit 33j.

The initial value calculation unit 33a reads the initial values of x₁ to x_{N}, bᵢ, Cⱼₖ, and dⱼ stored in the storage unit 32 and, based on these values, calculates the initial values of hᵢ^{XX} and hⱼ^{YX} by using Expressions (7) and (8). Also, the initial value calculation unit 33a calculates the initial value of yⱼ from the initial value of hⱼ^{YX} by using the following expression: yⱼ=f(hⱼ^{YX}).

Furthermore, the initial value calculation unit 33a reads, for example, Fᵢⱼ stored in the storage unit 32 and calculates, based on the calculated initial value of yⱼ and Fᵢⱼ, the initial value of hᵢ^{XY} by using Expression (6).

The h&y updating and holding unit 33b updates hᵢ^{XX}, hᵢ^{YX}, hⱼ^{XY}, and yⱼ and holds values of these.

The updated value of hᵢ^{XX} due to the change in the value of xⱼn may be represented by the following expression: hᵢ^{XX}=hᵢ^{XX}+W_{i,jn}Δxⱼₙ. The updated value of hⱼ^{YX} due to the change in the value of xⱼₙ may be represented by the following expression: hⱼ^{YX}=hⱼ^{YX}+C_{j,jn}Δxⱼₙ. The updated value of hⱼ^{XY} due to the change in the value of xⱼₙ may be represented by the following expression: hᵢ^{XY}=hᵢ^{XY}+FᵢⱼΔyⱼ. Calculation of Δyⱼ is performed by using an expression Δyⱼ=f(hⱼ^{YX})−yⱼ using the updated value of hⱼ^{YX}.

The flip candidate variable selection unit 33c selects a flip candidate state variable. For example, the flip candidate variable selection unit 33c selects a flip candidate state variable randomly or in a predetermined order. The flip candidate variable selection unit 33c outputs an identification number (1 to N) of the selected flip candidate state variable.

The Δx calculation unit 33d calculates the change amount of the value of the selected flip candidate state variable. For example, when the flip candidate state variable is xⱼₙ, Δxⱼₙ becomes −1 in the case where xⱼₙ changes from 1 to 0, and Δxⱼₙ becomes 1 in the case where the state variable xⱼₙ changes from 0 to 1.

The ΔE calculation unit 33e calculates, based on the product of the sum of two types of local fields and the change amount of the value of the flip candidate state variable, ΔE in the case where the value of the flip candidate state variable changes. For example, when the flip candidate state variable is xⱼₙ, ΔE is calculated by using the product of −Δxⱼₙ and the sum of hⱼₙ^{XY} and hⱼₙ^{XX} in the case where the value of xⱼₙ changes.

In the case where the change in the value of the flip candidate state variable is allowed by the flip determination unit 33g, the E updating and holding unit 33f updates E that is the value of the evaluation function indicated by Expression (3) based on ΔE calculated by the ΔE calculation unit 33e and holds E. The E updating and holding unit 33f may hold the smallest E out of Es having been obtained up to that time.

Based on the result of comparison between ΔE and a predetermined value, the flip determination unit 33g performs the flip determination process that determines whether to allow the change in the value of the flip candidate state variable. The predetermined value is, for example, a noise value obtained based on a random number and the value of the temperature parameter. The flip determination unit 33g determines that the change in the value of the flip candidate state variable is allowed in the case where, for example, ΔE is smaller than log (rand)×T which is an example of the noise value obtained based on a uniform random number (rand) greater than or equal to 0 and smaller than or equal to 1 and the temperature parameter (T).

The state holding unit 33h holds values of N state variables (x₁ to x_{N}).

The transition destination state calculation unit 33i calculates a transition destination state in which the value of the state variable of the identification number output by the flip candidate variable selection unit 33c out of the x₁ to x_{N} is changed.

In the case where the flip determination unit 33g determines that the change in the value of the state variable is allowed, the state updating unit 33j uses the transition destination state calculated by the transition destination state calculation unit 33i to update the state held by the state holding unit 33h.

Under the control of the control unit 31, the search unit 33 searches for a state in which the value of the evaluation function (energy) becomes the local minimum by repeatedly performing the flip determination process and the updating process of each parameter as described above.

The output unit 34 outputs a search result (calculation result) of the search unit 33. For example, in the case where the replica exchange method is performed, the output unit 34 outputs, as the calculation result, the state corresponding to the minimum energy in all the replicas out of the minimum energies stored after the above-described flip determination process has been repeatedly performed the predetermined number of times in each of the replicas.

For example, the output unit 34 may output and display the calculation result on the display 24a, transmit the calculation result to another information processing apparatus via the network 27a, or store the calculation result in an external storage device.

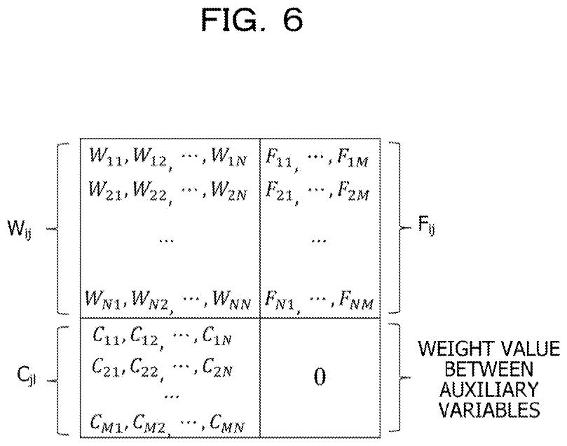

FIG. 6 illustrates an example of matrix information stored in the storage unit.

In the case where the number of the state variables and the number of the auxiliary variables included in the evaluation function of Expression (3) is N and M, respectively, Wᵢⱼ is an N×N matrix, Cⱼₗ in Expression (8) is an M×N matrix, and Fᵢⱼ in Expression (9) is an N×M matrix. Here, Wᵢⱼ=Wⱼᵢ. According to the present embodiment, it is assumed that the weight values between the auxiliary variables is 0.

Hereinafter, the processing procedure (a method of processing data) of the data processing apparatus 20 will be described. An example in which search is performed by using the replica exchange method is described below.

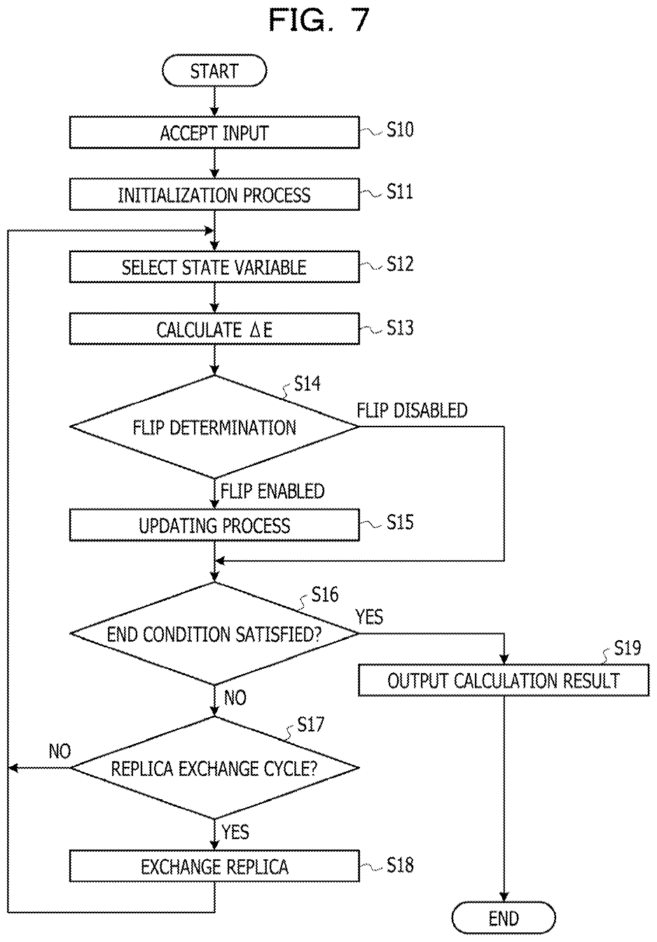

FIG. 7 is a flowchart illustrating a flow of an example of the method of processing data.

Step S10: The input unit 30 accepts input of the initial values of x₁ to x_{N}, the above-described problem information, and the calculation conditions. For example, the initial values of x₁ to x_{N} and the problem information having been input are stored in the storage unit 32, and the calculation conditions having been input are supplied to the control unit 31.

Step S11: The initialization process is performed for each of the replicas. An example of a procedure of the initialization process will be described later.

For each of the replicas, the control unit 31 causes the search unit 33 to perform processing of steps S12 to S16 below.

Step S12: The flip candidate variable selection unit 33c of the search unit 33 selects a candidate state variable the value of which is to be changed (updated).

Step S13: The ΔE calculation unit 33e calculates ΔE. Based on the product of the sum of two types of local fields and the change amount of the value of the flip candidate state variable, ΔE in the case where the value of the flip candidate state variable changes is calculated. For example, when the flip candidate state variable is xⱼₙ, the ΔE calculation unit 33e calculates ΔE by using the product of −Δxⱼₙ and the sum of hⱼₙ^{XY} and hⱼₙ^{XX} in the case where the value of xⱼₙ changes.

Step S14: The flip determination unit 33g performs the flip determination based on the result of comparison between ΔE and a predetermined value. In the case where the flip determination unit 33g determines that the change in the value of the state variable is allowed, (in the case of “FLIP ENABLED”), processing of step S15 is performed. In the case where the flip determination unit 33g determines that the change in the value of the state variable is not allowed (in the case of “FLIP DISABLED”), processing of step S16 is performed.

Step S15: The updating process is performed. In the processing of step S15, the state is updated by the state updating unit 33j, hᵢ^{XX}, hⱼ^{YX}, hᵢ^{XY}, and yⱼ are updated by the h&y updating and holding unit 33b, and E is updated by the E updating and holding unit 33f. An example of a procedure of the processing of step S15 will be described later.

Step S16: The control unit 31 determines whether the processing satisfies a predetermined end condition. For example, in the case where the number of times the search unit 33 performs the flip determination process has reached a maximum number of times of the flip determination, the control unit 31 determines that the end condition is satisfied. In the case where it is determined that the processing satisfies the predetermined end condition, processing of step S19 is performed. In the case where it is determined that the processing does not satisfy the predetermined end condition, processing of step S17 is performed.

Step S17: The control unit 31 determines whether the number of times of the flip determination indicates the replica exchange cycle. For example, in the case where a remainder of the number of times of the flip determination divided by a value indicative of the replica exchange cycle is 0, the control unit 31 determines that the number of times of the flip determination indicates the replica exchange cycle.

The control unit 31 performs processing of step S18 in the case where it is determined that the number of times of the flip determination indicates the replica exchange cycle. The control unit 31 causes the search unit 33 to repeat the processing from step S12 in the case where it is determined that the number of times of the flip determination does not indicate the replica exchange cycle.

Step S18: The control unit 31 performs a replica exchange process. For example, the control unit 31 randomly selects two replicas out of the plurality of replicas and exchanges the value of the set temperature parameter or the state between the two selected replicas with a predetermined exchange probability based on an energy difference between the replicas and the difference in the value of the temperature parameter between the replicas. After the processing of step S18, the control unit 31 causes the search unit 33 to repeat the processing from step S12.

Step S19: The output unit 34 outputs the calculation result. For example, the output unit 34 outputs, as the calculation result, the state corresponding to the minimum energy in all the replicas out of the minimum energies stored in the replicas. For example, the output unit 34 may output and display the calculation result on the display 24a, transmit the calculation result to another information processing apparatus via the network 27a, or store the calculation result in an external storage device.

Next, an example of the procedure of the initialization process of step S11 described above is described.

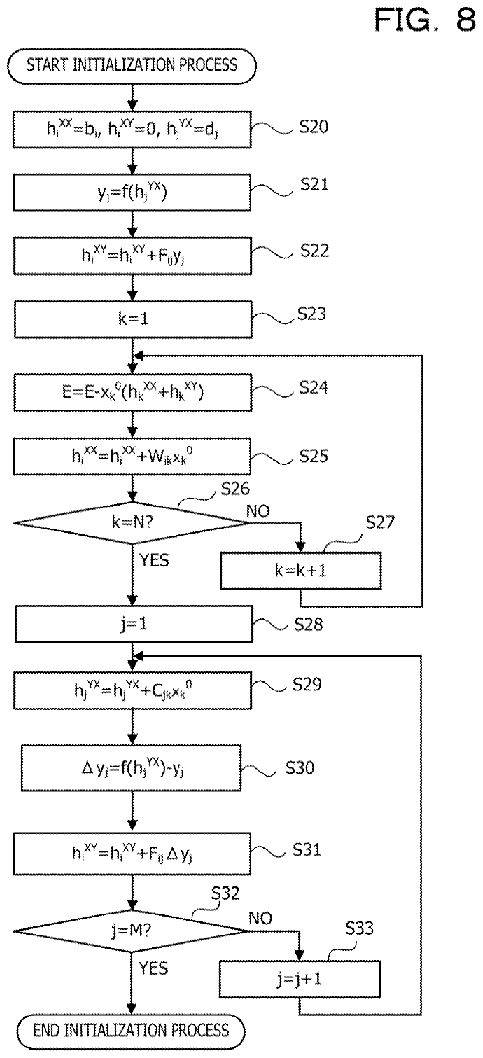

FIG. 8 is a flowchart illustrating a flow of the example of the procedure of the initialization process.

It is assumed that E is initialized to E₀ of Expression (3) (for example, 0).

First, the initial value calculation unit 33a sets hᵢ^{XX}=bᵢ, hᵢ^{XY}=0, and hⱼ^{YX}=dⱼ for hᵢ^{XX}, hᵢ^{XY}, and hⱼ^{YX}, of every i from 1 to N and every j from 1 to M (step S20). As for example, a value of −(k−3/2) is used in the case where the auxiliary variable yⱼ is an auxiliary variable for a k-field combined state variable (k≥3). The value yⱼ is determined by using (see FIG. 3 described above).

The initial value calculation unit 33a calculates yⱼ of every j from 1 to M by using an expression yⱼ=f(hⱼ^{YX}) (step S21). After the processing of step S21, the initial value calculation unit 33a updates hᵢ^{XY} of every i from 1 to N by using Fᵢⱼyⱼ of every j from 1 to M and an expression hᵢ^{XY}=hᵢ^{XY}+Fᵢⱼyⱼ (step S22).

Then, the initial value calculation unit 33a sets k that is a variable representative of the identification number of the state variable to k=1 (step S23) and updates E by using the following expression: E=E−xₖ⁰(hₖ^{XX}+hₖ^{XY}) (step S24). Furthermore, the initial value calculation unit 33a updates hᵢ^{XX} of every i from 1 to N by using the following expression: hᵢ^{XX}=hᵢ^{XX}+wᵢₖxₖ⁰ (step S25). Here, xₖ⁰ represents an initial value of the state variable with an identification number=k.

After the processing of step S25, the initial value calculation unit 33a determines whether k=N holds (step S26). In the case where it is determined that k=N does not hold, k=k+1 is set (step S27), and the processing from step S24 is repeated.

In the case where it is determined that k=N holds, the initial value calculation unit 33a sets the variable j indicative of the identification number of the auxiliary variable as j=1 (step S28). Hereinafter, it is assumed that the number of auxiliary variables is M.

By using an expression of hⱼ^{YX}=hⱼ^{YX}+Cⱼₖxₖ⁰, the initial value calculation unit 33a updates hⱼ^{YX} by using Cⱼₖxₖ⁰ of every k from 1 to N (step S29). For example, Cⱼₖ related to a state variable not included in the kth term is 0, and Cⱼₖ related to a state variable included in the kth term is +1 or −1 (σⱼ₁ to σⱼₖ in FIG. 1). Out of the state variables included in the kth term, Cⱼₖ related to a state variable that is a positive literal is +1, and a Cⱼₖ related to a state variable that is a negative literal is −1.

The initial value calculation unit 33a calculates Δyⱼ by using an expression of Δyⱼ=f(hⱼ^{YX})−yⱼ (step S30) and updates hᵢ^{XY} of every i from 1 to N by using an expression of hᵢ^{XY}=hᵢ^{XY}+FᵢⱼΔyⱼ (step S31). The product of Cⱼᵢ and Z_{<j1 . . . jk>} in Expression (3) represents Fᵢⱼ. Since Cⱼᵢ related to a state variable not included in the kth term is 0, Fᵢⱼ is also 0.

After the processing of step S31, the initial value calculation unit 33a determines whether j=M holds (step S32). In the case where it is determined that j=M does not hold, j=j+1 is set (step S33), and the processing from step S29 is repeated.

In the case where it is determined that j=M holds, the initial value calculation unit 33a ends the initialization process.

Next, an example of the procedure of the updating process of step S15 illustrated in FIG. 7 is described.

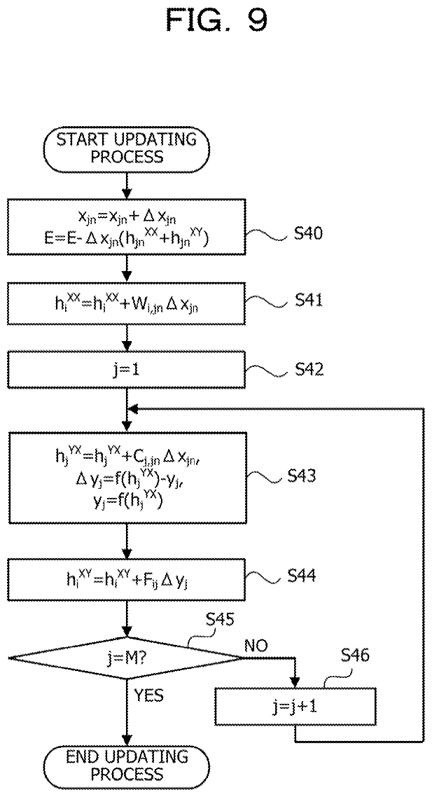

FIG. 9 is a flowchart illustrating a flow of the example of the procedure of the updating process. In FIG. 9, an example in the case where the change in the value of xⱼₙ is allowed is illustrated.

The state updating unit 33j uses the transition destination state calculated by the transition destination state calculation unit 33i to update the state held by the state holding unit 33h. The updated state is a state in which the value of xⱼₙ is changed so as to satisfy xⱼₙ=xⱼₙ+Δxⱼₙ. The E updating and holding unit 33f updates E by using the following expression: E=E−Δxⱼₙ(hⱼₙ^{XX}+hⱼₙ^{XY}) (step S40). Here, −Δxⱼₙ(hⱼₙ^{XX}+hⱼₙ^{XY})=ΔE and is supplied from the ΔE calculation unit 33e.

The h&y updating and holding unit 33b updates hᵢ^{XX} of every i from 1 to N by using the following expression: hᵢ^{XX}=hᵢ^{XX}+W_{i,jn}Δxⱼₙ (step S41). Also, the h&y updating and holding unit 33b sets j=1 (step S42) and updates hⱼ^{YX} with an updated value of hⱼ^{YX} (calculated when ΔE is calculated in step S13) represented by an expression of hⱼ^{YX}=hⱼ^{YX}+C_{j,jn}Δxⱼₙ. Also, the h&y updating and holding unit 33b updates Δyⱼ with an updated value of Δyⱼ (calculated when ΔE is calculated in step S13) represented by an expression of Δyⱼ=f(hⱼ^{YX})−yⱼ (step S43). By using hⱼ^{YX} before the updating, yⱼ may be represented as yⱼ=f(hⱼ^{YX}).

Then, the h&y updating and holding unit 33b calculates the updated value of hᵢ^{XY} of every i from 1 to N due to the change in the value of xⱼₙ by using the following expression: hᵢ^{XY}=hᵢ^{XY}+FᵢⱼΔyⱼ (step S44).

After the processing of step S44, the h&y updating and holding unit 33b determines whether j=M holds (step S45). In the case where it is determined that j=M does not hold, j=j+1 is set (step S46), and the processing from step S43 is repeated.

In the case where it is determined that j=M, the updating process ends.

The order of the processes illustrated in FIGS. 7 to 9 is merely exemplary and may be changed as appropriate.

With the data processing apparatus 20 and the method of processing data as described above, similar effects to those of the data processing apparatus 10 and the method of processing data according to the first embodiment may be obtained. For example, the discrete optimization problem represented by a higher-order evaluation function may be calculated without increasing the number of independent variables.

As has been described, the processing content described above may be realized by causing the data processing apparatus 20 to execute a program.

The program may be recorded in a computer-readable recording medium (for example, the recording medium 26a). As the recording medium, for example, a magnetic disk, an optical disk, a magneto-optical disk, a semiconductor memory, or the like may be used. Examples of the magnetic disk include an FD and an HDD. Examples of the optical disk include a CD, a CD-recordable (R)/rewritable (RW), a DVD, and a DVD-R/RW. The program may be recorded in a portable-type recording medium to be distributed. In this case, the program may be copied from the portable-type recording medium to another recording medium (for example, the HDD 23) to be executed.

### Third Embodiment

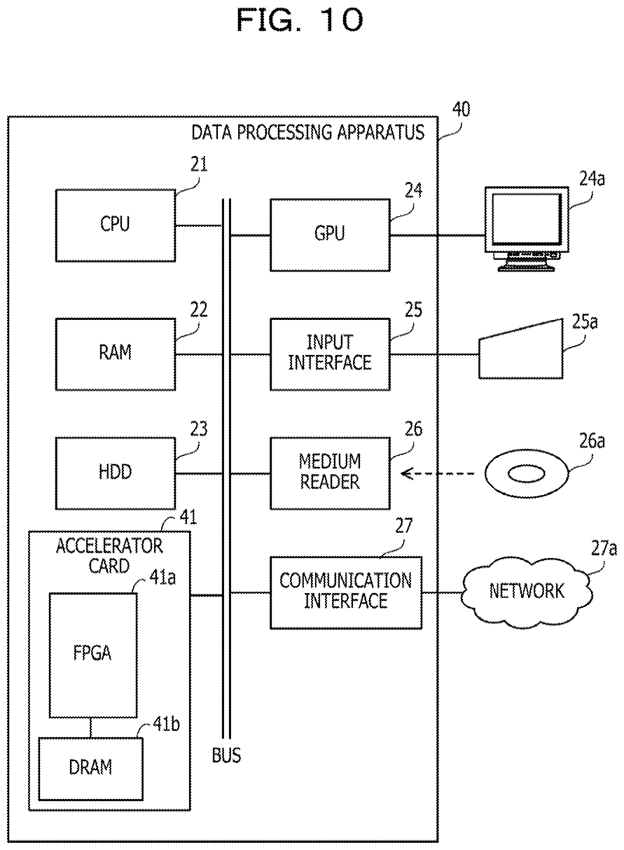

FIG. 10 illustrates an example of a data processing apparatus according to a third embodiment. In FIG. 10, the same elements as the elements illustrated in FIG. 4 are denoted by the same reference signs.

A data processing apparatus 40 according to the third embodiment includes an accelerator card 41 coupled to the bus.

The accelerator card 41 is a hardware accelerator that searches for a solution to a discrete optimization problem. The accelerator card 41 includes an FPGA 41a and a DRAM 41b.

In the data processing apparatus 40 according to the third embodiment, the FPGA 41a performs, for example, the processing of the control unit 31 and the search unit 33 illustrated in FIG. 5.

The DRAM 41b functions as the storage unit 32 illustrated in FIG. 5.

A plurality of accelerator cards 41 may be provided. In this case, for example, the processing (for example, the processing of steps S12 to S16 illustrated in FIG. 7) for the replicas may be performed in parallel.

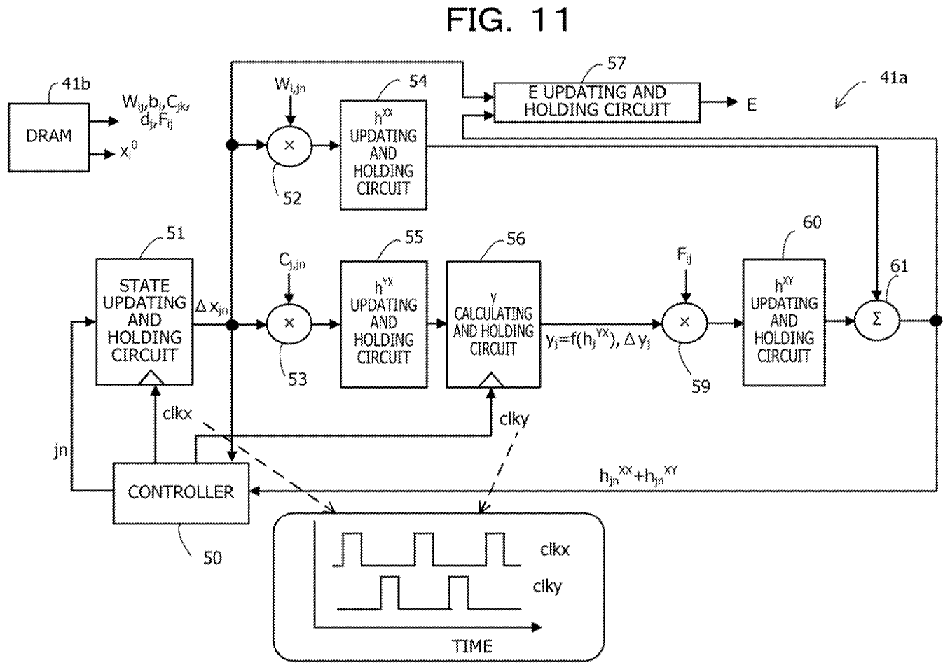

FIG. 11 illustrates a configuration of an example of an FPGA.

The FPGA 41a includes a controller 50, a state updating and holding circuit 51, multipliers 52 and 53, an h^{XX} updating and holding circuit 54, an h^{YX} updating and holding circuit 55, a y calculating and holding circuit 56, an E updating and holding circuit 57, a multiplier 59, an h^{XY} updating and holding circuit 60, and an addition circuit 61.

The controller 50 controls portions of the FPGA 41a. For example, as illustrated in FIG. 11, the controller 50 generates and outputs clock signals (clkx, clky) for determining operation timing of the state updating and holding circuit 51 and the y calculating and holding circuit 56.

The controller 50 has the function of selecting the flip candidate state variable and the function of determining whether to allow the change in the value of the flip candidate state variable based on a result of addition of two types of local fields output by the addition circuit 61. For example, in the case where xⱼₙ is selected as the flip candidate state variable, the controller 50 outputs the identification number=jn. Based on hⱼₙ^{XX}+hⱼₙ^{XY} which is the addition result output by the addition circuit 61 and Δxⱼₙ output by the state updating and holding circuit 51, the controller 50 calculates ΔE=−Δxⱼₙ(hⱼₙ^{XX}+hⱼₙ^{XY}). The controller 50 determines whether to allow the change in the value of xⱼₙ based on a result of comparison between ΔE and a noise value obtained based on a random number and the value of the temperature parameter.

The state updating and holding circuit 51 includes, for example, a register, a static random-access memory (SRAM), or the like and holds values of N state variables xᵢ (i=1 to N). An initial value xᵢ⁰ of N state variables xᵢ is read from the DRAM 41b and held in the state updating and holding circuit 51.

The state updating and holding circuit 51 outputs the change amount in the case where the value of the flip candidate state variable designated by the controller 50 is changed. For example, in the case where jn is designated as the identification number of the state variable, the state updating and holding circuit 51 outputs Δxⱼₙ which is the change amount of xⱼₙ.

In the case where the state updating and holding circuit 51 receives, from the controller 50, a signal indicative of allowing the change in the value of the flip candidate state variable, the state updating and holding circuit 51 updates the state by changing the value of the state variable.

The multiplier 52 outputs the products of the change amount of the state variable and the weight values in a row or a column related to the flip candidate state variable out of the matrix W of N×N weight values Wᵢⱼ stored in the DRAM 41b. For example, in the case where the flip candidate state variable is xⱼₙ, N weight values (W_{i,jn}) in the jn column out of the matrix W are read from the DRAM 41b, and the products of Δxⱼₙ and W_{i,jn} are output.

The multiplier 53 outputs the products of the change amount of the state variable and the coefficients in a column related to the flip candidate state variable out of the matrix C of M×N coefficients Cⱼₖ stored in the DRAM 41b. For example, in the case where the flip candidate state variable is xⱼₙ, M coefficients (C_{j,jn}) in the jn column out of the matrix C are read from the DRAM 41b, and the products of Δxⱼₙ and C_{j,jn} are output.

The h_{XX} updating and holding circuit 54 includes, for example, a register, an SRAM, or the like, holds N local fields hᵢ^{XX}, and calculates updated values of N local fields hᵢ^{XX} by adding each of N products output by the multiplier 52 to corresponding hᵢ^{XX} out of N local fields hᵢ^{XX}. An initial value of N local fields hᵢ^{XX}, bᵢ, is read from the DRAM 41b and held in the h_{XX} updating and holding circuit 54.

For example, the h_{YX} updating and holding circuit 55 includes a register, an SRAM, or the like and holds M local fields hⱼ^{YX} corresponding to the number of auxiliary variables. The h_{YX} updating and holding circuit 55 calculates updated values of M local fields hⱼ^{YX} by adding each of the M products output by the multiplier 53 to the corresponding hⱼ^{YX} out of M local fields hⱼ^{YX}. An initial value of M local fields hⱼ^{YX}, dⱼ, is read from the DRAM 41b and held in the h^{YX} updating and holding circuit 55.

The y calculating and holding circuit 56 calculates yⱼ which is M auxiliary variables and a difference (Δyⱼ) from the previously calculated yⱼ. As described above, yⱼ is determined by using the expression of yⱼ=f(hⱼ^{YX}). For example, the y calculating and holding circuit 56 outputs yⱼₙ that is a value of 0 or 1 in accordance with a result of comparison between the value of qⱼₙ represented by Expression (10) and −dⱼ (for example, k−3/2 described above).

For example, the y calculating and holding circuit 56 includes a register, an SRAM, or the like and holds M auxiliary variables yⱼ having been calculated.

For example, the E updating and holding circuit 57 includes a register, an SRAM, or the like, holds E that is the value of the evaluation function indicated in Expression (1), and calculates an updated value of E. For example, in the case where the change in the value of xⱼₙ is allowed, the updated value of E is obtained by using the following expression: E=E−(hⱼₙ^{XX}+hⱼₙ^{XY})Δxⱼₙ. As an initial value of E, E₀ of Expression (3) is set in the E updating and holding circuit 57.

The multiplier 59 outputs the product of Δyⱼ and Fᵢⱼ read from the DRAM 41b.

The h_{XY} updating and holding circuit 60 includes, for example, a register, an SRAM, or the like, holds N local fields hᵢ^{XY}, and calculates updated values of N local fields hᵢ^{XY} by adding FᵢᵢΔyⱼ, for each j, output by the multiplier 59 to corresponding hᵢ^{XY} out of N local fields hᵢ^{XY}. As an initial value of N local fields hᵢ^{XY}, 0 is set in the h^{XY} updating and holding circuit 60.

The addition circuit 61 outputs the addition result of the local field held by the h_{XX} updating and holding circuit 54 and the local field held in the h^{XY} updating and holding circuit 60. The addition result is used for the controller 50 and the E updating and holding circuit 57 to calculate ΔE. In the case where the value of xⱼₙ changes, the addition circuit 61 outputs hⱼₙ^{XX}+hⱼₙ^{XY} as illustrated in FIG. 1.

Also with the data processing apparatus 40 according to the third embodiment as described above, by using the FPGA 41a having the circuit configuration as illustrated in FIG. 11, the functions similar to those of the processing unit 12 of the data processing apparatus 10 according to the first embodiment are realized, and the effects similar to those of the data processing apparatus 10 according to the first embodiment are obtained.

### Fourth Embodiment

According to the examples of the embodiments described above, it is assumed that, as illustrated in FIG. 2, k auxiliary variables that are values of a single bit of 0 or 1 are used corresponding to the number of k state variables (xⱼ₁ to xⱼₖ) included in the kth term. However, as described below, when the auxiliary variable is a variable having a value of two bits or more, it is sufficient that a single auxiliary variable be used for k state variables included in the kth term.

FIG. 12 illustrates an example in which an auxiliary variable having a value of two bits is used. In FIG. 12, the auxiliary variable having a two-bit value is denoted by qₘ.

It is determined that, when the sum of k literals of xⱼ₁ to xⱼₖ is k, qₘ is 2. It is determined that, when this sum is k−1, qₘ is 1. It is determined that, when this sum is k−2 or smaller, qₘ is 0. In the example illustrated in FIG. 12, k literals of xⱼ₁ to xⱼₖ are all positive literals.

For example, hⱼ^{YX} calculated as σⱼ₁ to σⱼₖ=1, dₘ=−(k−2) may be set as qₘ. For example, in this case, qₘ=f(hⱼ^{YX})=hⱼ^{YX}.

The local fields (hⱼ₁^{XY} to hⱼₖ^{XY}) generated for xⱼ₁ to xⱼₖ by qₘ are converted from value of the qₘ by conversion units 70j1, 70jn, 70jk illustrated in FIG. 12.

For example, in the case where qₘ is 2, the constraint condition represented by the kth term is not satisfied, and accordingly, the conversion unit 70jn outputs Z_{<j1 . . . jk>} as hⱼₙ^{XY}. In the case where qₘ is 1, when the literal by xⱼₙ is 0, the constraint condition is not satisfied in the case where the value is changed, and accordingly, the conversion unit 70jn outputs Z_{<j1 . . . jk>} as hⱼₙ^{XY}. When the literal by xⱼₙ is 1, the constraint condition is satisfied in the case where the value is changed, and accordingly, the conversion unit 70jn outputs 0 as hⱼₙ^{XY}. When the value of xⱼₙ is any value, in the case where qₘ is 0, the constraint condition is satisfied after the change, and accordingly, the conversion unit 70jn outputs 0 as hⱼₙ^{XY}.

The conversion units 70j1 to 70jk as described above may be applied to the data processing apparatus 20 and 40 when, for example, the conversion units 70j1 to 70jk are incorporated into the h&y updating and holding unit 33b illustrated in FIG. 5 or incorporated as a logic circuit into the h^{XY} updating and holding circuit 60 illustrated in FIG. 11.

When the technique as described above is used, the number of auxiliary variables may be decreased. For example, when the number of state variable groups forming a k-field combination is mₖ, the number of auxiliary variables may be mₖ.

### Fifth Embodiment

Although it has been described that the state variables (x₁ to x_{N}) are binary variables having a value of 0 or 1 in the examples of the embodiments described above, the state variables (x₁ to x_{N}) may be spin variables having a value of −1 or 1.

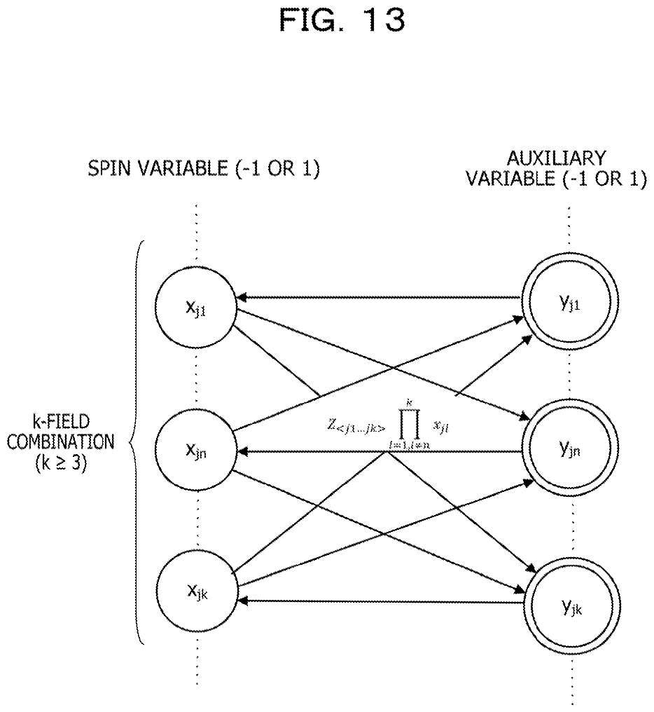

FIG. 13 illustrates an example in which spin variables are used as the state variables.

The combination relationship between xⱼ₁ to xⱼₖ forming the k-field combination and yⱼ₁ to yⱼₖ as the auxiliary variables is the same as that illustrated in FIG. 2.

In the case where the spin variable is used as the state variable, when changing of Δxᵢ is performed as Δxᵢ=−xᵢ−xᵢ=−2xᵢ, calculations at the time of updating the energy and hᵢ^{XX} similarly to those in the case where the binary variable is used (see steps S40 and S41 illustrated in FIG. 9) may be performed.

However, f(hⱼ^{YX}) for calculation of hᵢ^{XY} is different from that in the case where the binary variable is used. Since a sign is included in the spin variable, for example, hⱼₙ^{XY} generated when yⱼₙ which is an auxiliary variable is 1 for xⱼₙ which is a state variable included in the kth term may be represented by Expression (11) below without using a coefficient representative of the sign (corresponding to σⱼ₁ to σⱼₖ=1).

$${Z}_{〈 j 1 … jk 〉} {{\prod }_{l = 1 , l \neq n}}^{k} {x}_{jl} \qquad ( 11 )$$

In Expression (11), −Z_{<j1 . . . jk>} is used when the number of state variables having a value of −1 out of the state variables of xⱼ₁ to xⱼₖ except for xⱼₙ is an odd number and Z_{<j1 . . . jk>} is used when this number is an even number. To generate such hⱼₙ^{XY}, it is sufficient that Expression (12) below be used as hⱼₙ^{YX} in yⱼₙ=f(hⱼₙ^{YX}).

$${h}_{jn}^{YX} = \{ \begin{matrix}\frac{1}{2} {\sum }_{l = 1 , l \neq n}^{k} {x}_{jl} for odd k \\ \frac{1}{2} {\sum }_{l = 1 , l \neq n}^{k} {x}_{jl} - \frac{1}{2} for even k\end{matrix} \qquad ( 12 )$$

In the case where k is an odd number, an expression on the upper side of Expression (12) is used, and in the case where k is an even number, an expression on the lower side of Expression (12) is used. Regarding f(hⱼₙ^{YX}), f(hⱼₙ^{YX}) becomes a function that outputs −1 since, when hⱼₙ^{YX} is an even number, the number of the state variables having a value of −1 out of xⱼ₁ to xⱼₖ except for xⱼₙ is an odd number and becomes a function that outputs +1 when hⱼₙ^{YX} is an odd number.

When such yⱼₙ=f(hⱼₙ^{YX}) is used, hⱼₙ^{XY} may be represented as hⱼₙ^{XY}=Z_{<j1 . . . jk>}yⱼₙ.

When the method of calculating hⱼₙ^{XY} and the like are changed as described above, the spin variables may be handled as the state variables. When the spin variables are able to be handled, for example, the following effects may be obtained.

In the case where a problem originally formulated by using the spin variable is converted into a problem using the binary variable, the number of coefficients may increase. For example, in the case where a cubic evaluation function by the spin variable is converted into an evaluation function by the binary variable, the number of coefficients may increase due to generation of quadratic and linear terms by the conversion.

Directly handling the spin variable may decrease an increase in coefficient due to the conversion and the memory capacity for storing the coefficient.

Examples of the problem formulated by using the spin variable include, for example, problems related to quantum chemistry calculation. In quantum chemical calculation, when a Hamiltonian of a ground state of an electron system is expanded with the spin variable, a form including a higher-order spin product is obtained.

### Sixth Embodiment

As is the case with the fourth embodiment, even when the spin variable is used, the number of auxiliary variables used for k state variables included in the kth term may be one.

Since xⱼₗ is a spin variable in Expression (11) and xⱼₗ²=1, Expression (11) may be transformed as presented by Expression (13) below.

$${Z}_{〈 j 1 … jk 〉} {{\prod }_{l = 1 , l \neq n}}^{k} {x}_{jl} = {Z}_{〈 j 1 … jk 〉} {x}_{jn} {{\prod }_{l = 1}}^{k} {x}_{jl} = {Z}_{〈 j 1 … jk 〉} {x}_{jn} {q}_{m} \qquad ( 13 )$$

For example, hⱼₙ^{XY} for xⱼₙ may be calculated by generating qₘ which is one auxiliary variable and multiplying qₘ by Z_{<j1 . . . jk>}xⱼₙ. After the initial value (+1 or −1) has been set, qₘ is updated by inverting the sign every time any of values of xⱼ₁ to xⱼₖ changes. When the value of xⱼₙ changes, hⱼₙ^{XY} does not change, hⱼ₁^{XY} to hⱼₖ^{XY} for xⱼ₁ to xⱼₖ other than xⱼₙ change, and the changed part is Z_{<j1 . . . jk>}xⱼ₁Δqₘ to Z_{<j1 . . . jk>}xⱼₖΔqₘ.

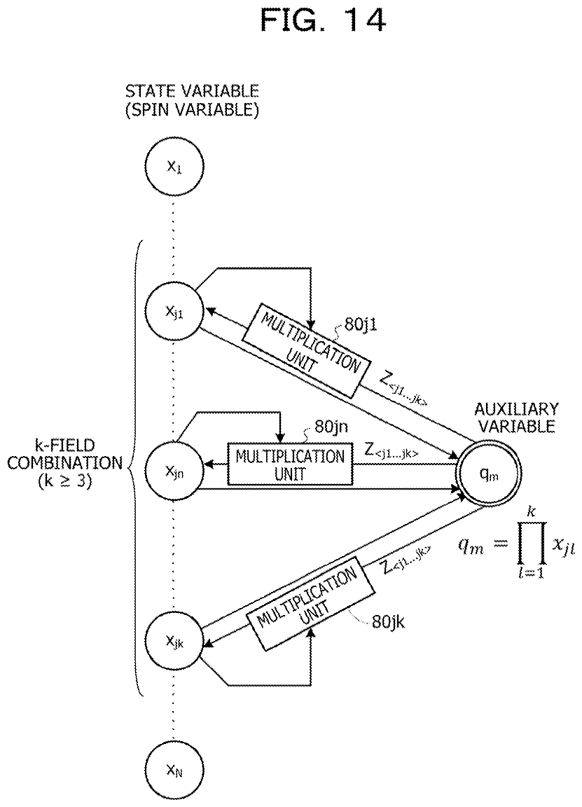

FIG. 14 illustrates an example in which the number of the auxiliary variables used for the state variables that are k spin variables included in the kth term is one.

The local fields (hⱼ₁^{XY} to hⱼₖ^{XY}) generated for the xⱼ₁ to xⱼₖ by qₘ are obtained by multiplying Z_{<j1 . . . jk>}qₘ by the values of the xⱼ₁ to xⱼₖ by using multiplication units 80j1 , . . . , 80jn, . . . , 80jk illustrated in FIG. 14.

The multiplication units 80j1 to 80jk as described above may be applied to the data processing apparatus 20 and 40 when, for example, the multiplication units 80j1 to 80jk are incorporated into the h&y updating and holding unit 33b illustrated in FIG. 5 or incorporated as a logic circuit (multiplier) into the h_{XY} updating and holding circuit 60 illustrated in FIG. 11.

When the technique as described above is used, the auxiliary variable may be generated as a neuron of multiple inputs and multiple outputs for one kth order combination. When a set of Z_{<j1 . . . jk>} and the identification numbers (j1 to jk) of the state variables included in the kth term are read from the memory (for example, the storage unit 32 or the DRAM 41b) once, the local fields (hⱼ₁^{XY} to hⱼₖ^{XY}) for xⱼ₁ to xⱼₖ may be calculated.

### Seventh Embodiment

Although it is assumed in the examples of the embodiments described above that the auxiliary variables (such as yⱼ₁ to yⱼₖ illustrated in FIG. 2) are used in a single layer and the weight values between the auxiliary variables is 0 as illustrated in FIG. 6, the auxiliary variables may be used in a plurality of layers as described below.

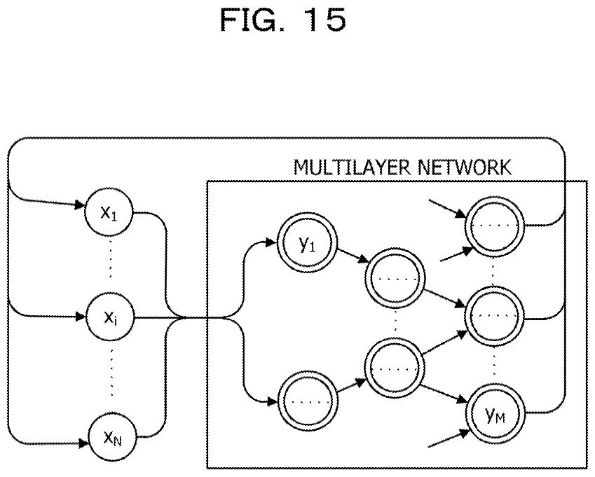

FIG. 15 illustrates an example in which a plurality of auxiliary variables are used in a plurality of layers. In the example illustrated in FIG. 15, the auxiliary variables of y₁ to y_{M} form a multilayer network.

By setting the initial value and the weight value, y₁ to y_{M} may also function as a single-layer auxiliary variable group (or a single auxiliary variable) that causes the state variables included in the above-described kth term to generate local fields related to the kth term.

Furthermore, as illustrated in FIG. 15, when y₁ to y_{M} is formed in a plurality of layers and the weight value between y₁ to y_{M} is set, not only a higher-order term but also a more usual cost function may be handled.

### Calculation Example

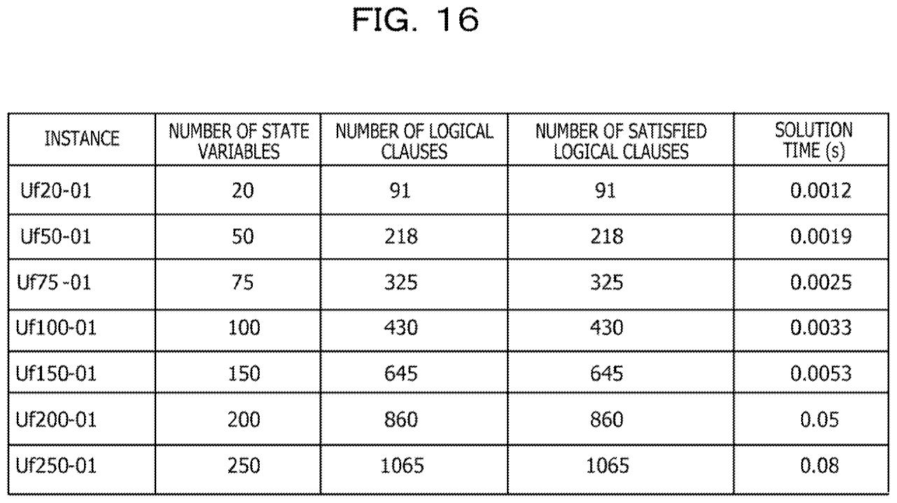

FIG. 16 illustrates an example of calculation results.

FIG. 16 illustrates an example in which a SAT-type discrete optimization problem with a known solution (seven instances in FIG. 16) is calculated by using the data processing apparatus 20 as described in the second embodiment. In each of the instances, the number of state variables included in the evaluation function is different from the number of logical clauses of higher-order terms. According to the example of the calculation results illustrated in FIG. 16, all the logical clauses in all the seven instances are satisfied, and the solutions are obtained by the amounts of time indicated by “SOLUTION TIME (s)”.

Although aspects of the data processing apparatus, the program, and the method of processing data according to the present disclosure have been described above based on the embodiments, the embodiments are merely exemplary and not limited to the above description.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing apparatus of searching for a combination of values of a plurality of state variables with which a value of an evaluation function which includes the plurality of state variables becomes a local minimum or a local maximum, the data processing apparatus comprising:
a storage device configured to store a first coefficient indicating a magnitude of interaction between k state variables (k is an integer of greater than or equal to three) out of the plurality of state variables included in a kth order term of the evaluation function; and
a processor configured to perform processing including:
calculating a first local field indicative of a change amount of the kth order term in a case where a value of a first state variable out of the k state variables changes based on a value of a first variable and the first coefficient read from the storage device, the value of the first variable being a value obtained based on values of the k state variables and a plurality of second coefficients respectively representative of influences of the k state variables on the first variable; and
determining, based on a result of comparison, whether to allow a change in the value of the first state variable, the result of the comparison being obtained by comparing between a predetermined value and a product of a sum of the first local field and a second local field indicative of a change amount of quadratic and lower-order terms of the evaluation function in the case where the value of the first state variable changes and a change amount of the first state variable.

2. The data processing apparatus according to claim 1, wherein
the plurality of second coefficients are −1 or 1.

3. The data processing apparatus according to claim 1, wherein
the value of the first variable is determined for each of the k state variables, and wherein
the value of the first variable determined for the first state variable is determined based on a total sum of products of values of second state variables, out of the k state variables, other than the first state variable and second coefficients related to the second state variables out of the plurality of second coefficients.

4. The data processing apparatus according to claim 3, wherein
the first local field is a product of a third coefficient, out of the plurality of second coefficients, related to the first state variable, the value of the first variable determined for the first state variable, and the first coefficient.

5. The data processing apparatus according to claim 1, wherein
a value of the first variable common to the k state variables is determined, wherein
it is determined that the value of the first variable determined for the first state variable is 2 when a sum of k literals with the k state variables is k,
it is determined that the value of the first variable determined for the first state variable is 1 when the sum of the k literals with the k state variables is k−1, and
it is determined that the value of the first variable determined for the first state variable is 0 when the sum of the k literals with the k state variables is smaller than or equal to k−2, and wherein
the processing unit sets the first local field as the first coefficient when the value of the first variable is 2,
the processing unit sets the first local field as the first coefficient when the value of the first variable is 1 and a literal with the first state variable is 0,
the processing unit sets the first local field to 0 when the value of the first variable is 1 and the literal with the first state variable is 1, and
the processing unit sets the first local field to 0 when the value of the first variable is 0.

6. The data processing apparatus according to claim 1, wherein
each of the plurality of state variables has a value of −1 or 1, and the first variable has a value of −1 or 1, wherein
the processing unit determines the value of the first variable for each of the k state variables, and wherein
the first local field for the first state variable is a product of an infinite product of the values of the second state variables, out of the k state variables, other than the first state variable, the first coefficient, and the first variable.

7. The data processing apparatus according to claim 1, wherein
each of the plurality of state variables has a value of −1 or 1, and the first variable has a value of −1 or 1, and wherein
the processing unit calculates
the value of the first variable common to the k state variables with an infinite product of the values of the k state variables and
the first local field for the first state variable with a product of the value of the first variable, the first coefficient, and the value of the first state variable.

8. A non-transitory computer-readable recording medium storing a program of searching for a combination of values of a plurality of state variables with which a value of an evaluation function which includes the plurality of state variables becomes a local minimum or a local maximum, the program including instructions which, when the program is executed by a computer, cause the computer to execute processing, the processing comprising:
obtaining a first coefficient from a storage device that stores the first coefficient representative of a magnitude of interaction between k state variables (k is an integer of greater than or equal to three) out of the plurality of state variables included in a kth order term of the evaluation function;
calculating a first local field indicative of a change amount of the kth order term in a case where a value of a first state variable out of the k state variables changes based on a value of a first variable and the first coefficient read from the storage device, the value of the first variable being a value obtained based on values of the k state variables and a plurality of second coefficients respectively representative of influences of the k state variables on the first variable; and
determining, based on a result of comparison, whether to allow a change in the value of the first state variable, the result of the comparison being obtained by comparing between a predetermined value and a product of a sum of the first local field and a second local field indicative of a change amount of quadratic and lower-order terms of the evaluation function in the case where the value of the first state variable changes and a change amount of the first state variable.

9. A computer-implemented method of searching for a combination of values of a plurality of state variables with which a value of an evaluation function which includes the plurality of state variables becomes a local minimum or a local maximum, the method comprising:
obtaining a first coefficient from a storage device that stores the first coefficient representative of a magnitude of interaction between k state variables (k is an integer of greater than or equal to three) out of the plurality of state variables included in a kth order term of the evaluation function;
calculating a first local field indicative of a change amount of the kth order term in a case where a value of a first state variable out of the k state variables changes based on a value of a first variable and the first coefficient read from the storage device, the value of the first variable being a value obtained based on values of the k state variables and a plurality of second coefficients respectively representative of influences of the k state variables on the first variable; and
determining, based on a result of comparison, whether to allow a change in the value of the first state variable, the result of the comparison being obtained by comparing between a predetermined value and a product of a sum of the first local field and a second local field indicative of a change amount of quadratic and lower-order terms of the evaluation function in the case where the value of the first state variable changes and a change amount of the first state variable.
